(19) United States
(12) Patent Application Publication
(10) Pub. No.: US 2026/0270638 A1
(43) Pub. Date: Sep. 10, 2026

(54) SONIFICATION OF NAVIGATION SEARCH RESULTS

(71) Applicant: GM Global Technology Operations LLC, Detroit, MI (US)

(72) Inventors: Scott Michael Pennock, Lake Orion, MI (US); Bassam S. Shahmurad, Rochester Hills, MI (US)

(73) Assignee: GM Global Technology Operations LLC, Detroit, MI (US)

(21) Appl. No.: 19/074,907

(22) Filed: Mar. 10, 2025

(51) Int. Cl. H04S 7/00; G01C 21/36; G06F 16/9537; G10L 15/22; H04R 5/02

(52) U.S. Cl. CPC H04S 7/302; G01C 21/3629; G06F 16/9537; H04R 5/02; G10L 15/22; H04R 2499/13; H04S 2400/11; H04S 2400/15

(57) ABSTRACT

A method of sonification of search results includes, while a user is disposed within a cabin of a vehicle, obtaining a response to a query issued by the user, the response including a list of potential matches to the query, each potential match including respective embedded metadata. For each potential match, the method also includes extracting embedded metadata corresponding to the potential match, determining, based on the embedded metadata, a spatially disposed location within a playback sound-field for the user to perceive as a sound-source of the potential match, and rendering output audio signals characterizing the potential match through a speaker array in the cabin to produce the playback sound-field. Here, the user perceives the potential match as emanating from the sound-source at the spatially disposed location within the playback sound-field.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to the sonification of navigation search results. Navigation systems in vehicles have become an essential tool for drivers, providing real-time directions and information about points of interest. These systems typically convey navigation search results through visual displays, which present a map and relevant data such as the names and addresses of destinations. The visual interface often includes icons or markers indicating the locations of search results, and users can interact with the display to select or get more information about these results.

Naturally, these navigation systems generally require the user to look at the display to fully understand respective locations of the search results. This visual dependency means that users must interpret the information presented on the screen to comprehend the layout and proximity of various destinations with respect to the vehicle's current location. While some systems may offer auditory feedback, such as spoken directions, to assist the driver in selecting a point of interest from a list of search results, communicating all location information using verbal prompts may take considerable time. As such, providing spatial cues to indicate a direction and distance of a point of interest may be comprehended by the vehicle user more quickly and easily.

### SUMMARY

One aspect of the disclosure provides a computer-implemented method for the sonification of navigation search results that when executed on data processing hardware causes the data processing hardware to perform operations that include, while a user is disposed within a cabin of a vehicle, obtaining a response to a query issued by the user, the response including a list of potential matches to the query, each potential match including respective embedded metadata. For each potential match, the operations also include extracting embedded metadata corresponding to the potential match, determining, based on the embedded metadata, a spatially disposed location within a playback sound-field for the user to perceive as a sound-source of the potential match, and rendering output audio signals characterizing the potential match through a speaker array in the cabin to produce the playback sound-field. Here, the user perceives the potential match as emanating from the sound-source at the spatially disposed location within the playback sound-field.

Implementations of the disclosure may include one or more of the following optional features. In some implementations, the operations further include receiving location information of the vehicle. In these implementations, rendering the output audio signals may include modulating the output audio signals based on a distance between the location information of the vehicle and the embedded metadata of the potential match. In some examples, the operations further include, while rendering the output audio signals characterizing the potential match, simultaneously displaying a corresponding visual cue in a graphical user interface of the vehicle.

In some implementations, the operations further include identifying a user preference associated with one of the potential matches in the list of potential matches, the user preference stored in a user profile of the user. In these implementations, rendering the output audio signals characterizing the potential match associated with the user preference includes rendering a user-defined audio output signal. In some examples, the operations further include receiving audio data characterizing a spoken utterance of the query issued by the user and captured by a microphone in the cabin of the vehicle. In these examples, the audio data characterizing the spoken utterance of the query may indicate a particular location of the user in the cabin of the vehicle. Here, the playback sound-field may be centered on the particular location of the user in the cabin of the vehicle. In some implementations, the playback sound-field represents locations outside of the cabin of the vehicle.

Another aspect of the disclosure provides a system for the sonification of navigation search results that includes data processing hardware and memory hardware in communication with the data processing hardware. The memory hardware stores instructions that when executed by the data processing hardware cause the data processing hardware to perform operations that include, while a user is disposed within a cabin of a vehicle, obtaining a response to a query issued by the user, the response including a list of potential matches to the query, each potential match including respective embedded metadata. For each potential match, the operations also include extracting embedded metadata corresponding to the potential match, determining, based on the embedded metadata, a spatially disposed location within a playback sound-field for the user to perceive as a sound-source of the potential match, and rendering output audio signals characterizing the potential match through a speaker array in the cabin to produce the playback sound-field. Here, the user perceives the potential match as emanating from the sound-source at the spatially disposed location within the playback sound-field.

This aspect may include one or more of the following optional features. In some implementations, the operations further include receiving location information of the vehicle. In these implementations, rendering the output audio signals may include modulating the output audio signals based on a distance between the location information of the vehicle and the embedded metadata of the potential match. In some examples, the operations further include, while rendering the output audio signals characterizing the potential match, simultaneously displaying a corresponding visual cue in a graphical user interface of the vehicle.

In some implementations, the operations further include identifying a user preference associated with one of the potential matches in the list of potential matches, the user preference stored in a user profile of the user. In these implementations, rendering the output audio signals characterizing the potential match associated with the user preference includes rendering a user-defined audio output signal. In some examples, the operations further include receiving audio data characterizing a spoken utterance of the query issued by the user and captured by a microphone in the cabin of the vehicle. In these examples, the audio data characterizing the spoken utterance of the query may indicate a particular location of the user in the cabin of the vehicle. Here, the playback sound-field may be centered on the particular location of the user in the cabin of the vehicle. In some implementations, the playback sound-field represents locations outside of the cabin of the vehicle.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a schematic view of an example system for the sonification of navigation search results.

FIG. 2 is a schematic view of example components of the system of FIG. 1.

FIG. 3 is a schematic view of example components of the system of FIG. 1.

FIG. 4 is a schematic view of a graphical user interface of the system of FIG. 1.

FIG. 5 is a flowchart of an example arrangement of operations for a method of the sonification of navigation search results.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

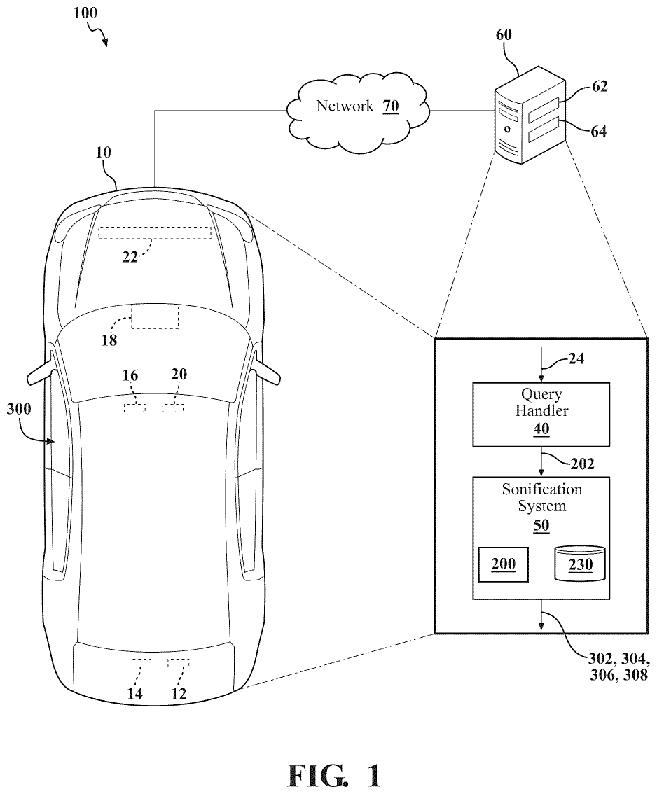

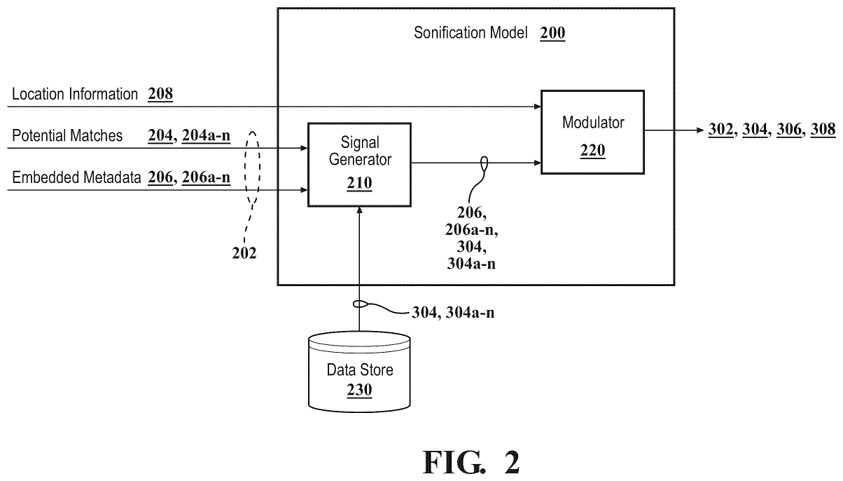

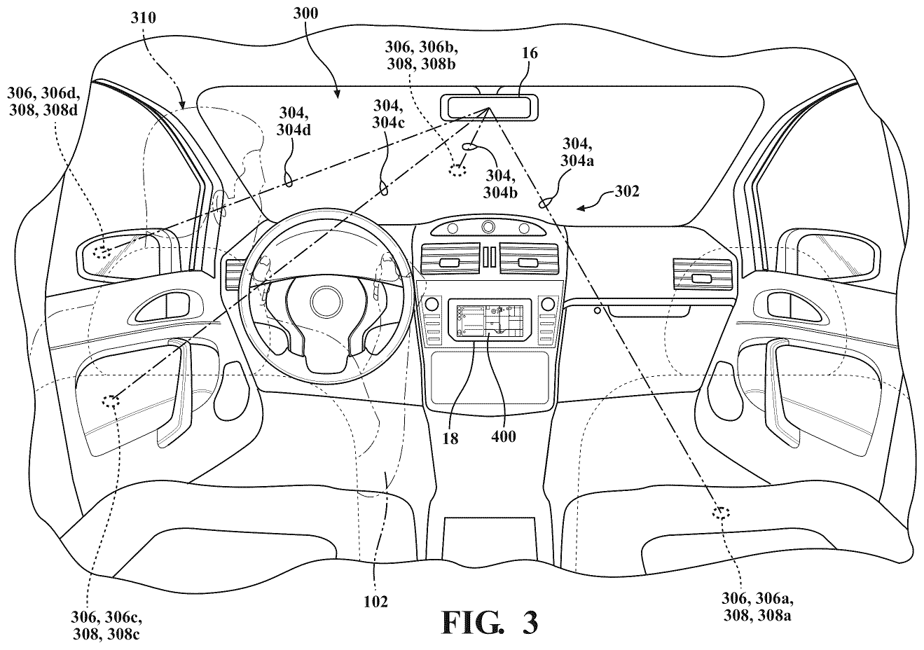

Referring to FIG. 1, in some implementations, a system 100 includes a vehicle 10 in communication with a remote system 60 via a network 70. The vehicle 10 and/or the remote system 60 include a query handler 40 and a sonification system 50 that each execute while a user 102 is disposed within a cabin 300 of the vehicle 10. Briefly, and as described in further detail below, the query handler 40 receives a query 24 from the user 102 and generates a response 202 to the query 24. For instance, the response 202 may include a list of navigation search results relative to the vehicle 10. Thereafter, the sonification system 50 executes a sonification model 200 (FIG. 2) configured to receive the response 202 to the query 24 issued by the user 102 and convert the response 202 into a playback sound-field 302 (FIG. 3) that maps the directionality and distance of the response 202 to one or more spatially disposed locations 306 within the playback sound-field 302. Notably, rather than rely on verbal prompts to guide the user 102 through the response 202, which rely on higher level cognitive mechanisms for the user 102 to follow, the playback sound-field 302 relays the response 202 by communicating with the user 102 using auditory spatial cues, which are processed using lower-level perceptual mechanisms. As such, the user 102 may more quickly comprehend the response 202 while limiting the need for the user 102 to consult a visual display (e.g., a graphical user interface 18) in the vehicle 10.

In the example shown, the query handler 40 and the sonification system 50 are implemented within the vehicle 10. However, the query handler 40 and the sonification system 50 may be implemented in any other propulsion system, such as, without limitation, motorcycles, trucks, off-road vehicles, farm equipment, trains, aircraft, and the like. The vehicle 10 includes data processing hardware 12 and memory hardware 14 storing instructions that when executed on the data processing hardware 12 cause the data processing hardware 12 to perform operations. Additionally, while the query handler 40 and the sonification system 50 are described as being implemented by the data processing hardware 12 and memory hardware 14 of the vehicle 10, their respective operations can be implemented on other computing devices (e.g., computing devices in communication with the vehicle 10), such as, without limitation, a smart phone, tablet, smart display, desktop/laptop, smart watch, smart appliance, or smart glasses/headset.

As shown in FIG. 1, the vehicle 10 further includes a speaker array 16 (also referred to as a loudspeaker array 16), a graphical user interface 18, and a microphone array 20 each disposed within the cabin 300 of the vehicle 10, and through which the user 102 may interact with the query handler 40. The microphone array 20 may include one or more microphones 20 configured to capture acoustic sounds (i.e., audio data) characterizing utterances such as speech directed toward the query handler 40. The speaker array 16 may include two or more loudspeakers that may output audio such as music and/or synthesized speech from the query handler 40. While the speaker array 16 and the microphone array 20 are generally shown disposed within a headliner of the interior of the vehicle 10 at a forward portion of the vehicle 10, it should be appreciated that the speaker array 16 and/or the microphone array 20 may be distributed throughout the cabin 300 of the vehicle 10. The vehicle 10 may further include a sensor system 22 including a global positioning system (GPS), one or more cameras, a forward collision mitigation system, radio detection and ranging (RADAR), light detection and ranging (LIDAR) capable of capturing image data, and other external sensors of the vehicle 10. While the sensor system 22 shown in FIG. 1 is disposed on a front side of the vehicle 10, it should be appreciated that the sensor system 22 may include sensors located throughout the vehicle 10. For example, the sensor system 22 may provide 360-degree surround sensing of an environment of the vehicle 10.

The network 70 may include a wireless local area network (WLAN) that facilitates communication and interoperability between the vehicle 10 and the remote system 60 within an environment of the vehicle 10. Thus, the network 70 can include Wireless Fidelity (WiFi®) (e.g., IEEE 802.11), Low-Rate Wireless Personal Area Networks (e.g., IEEE 802.15.4), worldwide interoperability for microwave access (WiMAX), 3G, 4G, Long Term Evolution (LTE), 5G, digital subscriber line (DSL), Bluetooth, Near Field Communication (NFC), or any other wireless standards, or Ethernet (e.g., IEEE 802.3). The system 100 may additionally include one or more access points (AP) (not shown) configured to facilitate wireless communication between the vehicle 10 and the remote system 60.

The remote system 60 (e.g., server, cloud computing environment) also includes data processing hardware 62 and memory hardware 64 storing instructions that when executed on the data processing hardware 62 cause the data processing hardware 62 to perform operations. In some examples, execution of the query handler 40 and the sonification system 50 is shared across the vehicle 10 and the remote system 60. As shown in FIG. 1, the query handler 40 manages queries issued by the user 102 disposed within the cabin 300 of the vehicle 10. For instance, the query handler 40 may include a speech recognizer (not shown) employing an automatic speech recognition model that may perform speech recognition or semantic interpretation on audio data corresponding to the query 24 issued by the user 102. The query handler 40 may further include a natural language understanding (NLU) module that performs query interpretation on the query 24 to identify speech commands in the query 24 and retrieve a response 202 including a list of potential matches 204 to the query 24. For instance, the user 102 may issue a query 24 “find an EV charging station,” where the query handler 40 then generates, as output, a response 202 including a list of potential matches 204 (i.e., EV charging stations in proximity to the location of the vehicle 10) to the query 24. These potential matches 204 may also be referred to as points of interest that the user 102 may wish to navigate to for services (e.g., EV charging).

With continued reference to FIGS. 1 and 2, the sonification system 50 executes the sonification model 200 that is configured to receive the response 202 generated by the query handler 40. The sonification model 200 includes a signal generator 210 and a modulator 220. Additionally, a sonification model 200 has access to a datastore 230 stored on the memory hardware 14, 64 of the system 100. As shown, in addition to the list of potential matches 204, the response 202 may further include embedded metadata 206 for each respective potential match 204 in the list of potential matches 204. For instance, the embedded metadata 206 may include one or more of, without limitation, location information for the potential match 204, distances to the potential match 204, or capabilities (e.g., charging rate of an EV charging station) of the potential match 204. The signal generator 210 may receive the list of potential matches 204 and the respective embedded metadata 206 and process the potential matches 204 and the respective embedded metadata 206 to identify the correct output audio signal 304 for the response 202. For each potential match 204 in the list of potential matches 204, the signal generator 210 may extract the embedded metadata 206 corresponding to the potential match 204. Thereafter, based on the extracted embedded metadata 206, the signal generator 210 may query the datastore 230 to obtain one or more output audio signals 304 that correspond to the content of the response 202. In other words, the output audio signals 304 may be categorized in the datastore 230 depending on the category of the potential match 204, where different categories of potential matches 204 may have different corresponding output audio signals 304. In this example, the signal generator 210 may identify, based on the respective extracted embedded metadata 206 of the response, that the potential matches 204 all relate to the category of coffee shops, and retrieve, from the datastore 230, output audio signals 304 corresponding to a “drip” sound. In other examples, where the signal generator 210 identifies, based on the respective extracted embedded metadata 206 of the response, that the potential matches 204 all relate to the category of EV charging stations, the signal generator 210 retrieves, from the datastore 230, output audio signals 304 corresponding to a “hum” sound.

Notably, the datastore 230 may store both standard (i.e., created by an equipment manufacturer of the vehicle 10) output audio signals 304, as well as user-defined output audio signals 304. For instance, the datastore 230 may include a user profile that stores user preferences associated with the user 102. Here, the user 102 may build its user profile with user preferences including user-defined output audio signals 304 recorded by the user 102. Here, the user preferences may assign the user-defined output audio signal 304 to either a particular point of interest (i.e., potential match 204), or a category of points of interest. The particular point of interest may include a potential match 204 that the user 102 has tagged and/or visited frequently. For instance, if a user 102 has repeatedly navigated to a particular grocery store, the user profile may store a personalized user-defined output audio signal 304 as a user preference that is unique to the particular grocery store and differs from the output audio signal 304 of other grocery stores. In subsequent queries, the signal generator 210 may identify when the particular grocery store is present in the list of potential matches 240 and render the output audio signal 304 associated with the user preference. Here, by personalizing the output audio signal 304 based on the preferences of the user 102, the user 102 is given a cue that differentiates the particular grocery store from the list of potential matches 204 when the user-defined output audio signals 304 are rendered.

With continued reference to FIGS. 2 and 3, the modulator 220 receives, as input, the extracted embedded metadata 206 for each of the corresponding potential matches 204, and the corresponding output audio signals 304 for each of the potential matches 204, and determines, for each potential match 204, and based on the extracted embedded metadata 206, a spatially disposed location 306 within a playback sound-field 302 for the user 102 to perceive as a sound-source 308 of the potential match 204. Here, the modulator 220 may further receive, as input, the location information 208 of the vehicle 10, and determine the spatially disposed location 306 within the playback sound-field 302 based on the location information 208 of the vehicle 10 relative to the potential match 204. In other words, the modulator 220 may determine a particular direction located within the cabin 300 as a user-perceived sound-source 308 of the potential match 204. Thereafter, for each potential match 204, the modulator 220 renders the output audio signal 304 characterizing the potential match 204 through the loudspeaker array 16 in the cabin 300 to produce the playback sound-field 302. Here, the user 102 perceives the potential match 204 as emanating from the sound-source 308 at the spatially disposed location 306 within the playback sound-field 302. In producing the playback sound-field 302, the modulator 220 embeds the extracted embedded metadata 206 and/or the location information 208 in the output audio signals 304 themselves by, for example, applying interaural time differences, interaural level differences, direct-to-reflected sound ratios, etc. to provide spatial cues for the user 102.

In some instances, the modulator 220 processes/modifies the output audio signal 304 before rendering it to produce the playback sound-field 302. In these instances, the modulator may modulate the output audio signals 304 based on the distance between the location information 208 of the vehicle 10 and the extracted embedded metadata 206 of the potential match 204. For instance, the modulator 220 may consider the distance between the vehicle 10 and the potential match 204 and adjust a volume level of the output audio signal 304 to indicate whether the potential match 204 is close (i.e., by increasing the volume of the output audio signal 304) or far (i.e., by decreasing the volume of the output audio signal 304). Similarly, the modulator 220 may modulate the sound attributes (e.g., pitch, tone, perceived size, duration, repetitions, repetition rate, etc.) of the output audio signal 304 to communicate the capabilities (i.e., fast charging or standard EV charging stations) indicated by the extracted embedded metadata 206 of the potential match 204.

Referring to FIG. 3, the cabin 300 of the vehicle 10 is shown with the user 102 disposed therein. Here, the modulator 320 renders (via the loudspeaker array 16) the output audio signals 304a-304d to produce the spatial playback sound-field 302 that maps the particular direction and/or distance for each potential match 204 to a spatially disposed location 306a-d. Here, the user 102 perceives a sound-source 308a-d of each potential match 204 as emanating from the respective spatially disposed location 306a-d within the playback sound-field 302. As shown, the playback sound-field 302 fills the cabin 300 of the vehicle 10; however, it should be understood that the playback sound-field 302 represents locations outside of the cabin 300 of the vehicle 10 to which the user 102 may navigate.

The modulator 220 may render the output audio signals 304a-304d individually in the same order that the potential matches 204 appear in the list of potential matches 204. In other instances, the modulator 220 may order the rendition of the output audio signals 304 based on a likelihood (i.e., based on preferences of the user 102) that the user 102 will select the potential match 204 as a navigation destination. Optionally, the modulator 220 may render the output audio signals initially in a first round-robin style, and then in a second round that incorporates additional auditory information (i.e., distance, orientation, capabilities) about the potential match 204.

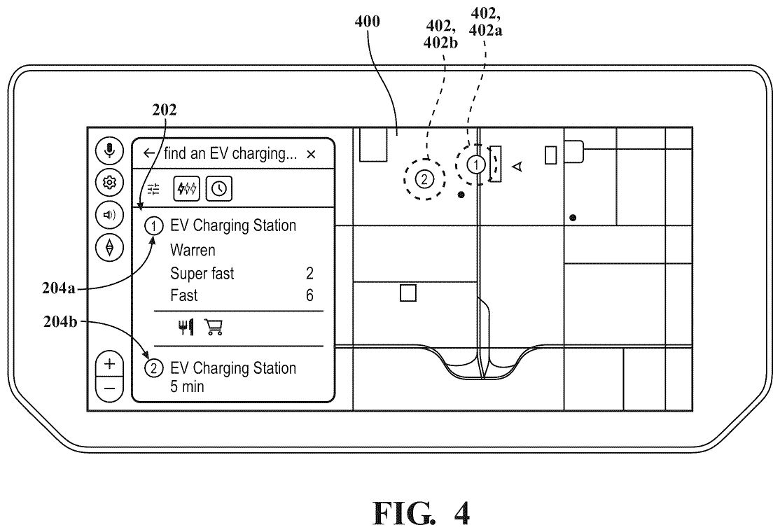

Referring to FIG. 4, in some instances, the sonification system 50 further incorporates visual information into a screen 400 of a graphical user interface 18 of the vehicle 10. As shown, the screen 400 shows a maps application including a response 202 including two potential matches 204a, 204b to the query “find an EV charging station.” Here, the graphical user interface 18 may further include visual cues (i.e., graphical elements) 402a, 402b that are displayed on the screen 400 of the graphical user interface 18. While rendering the output audio signals 304 characterizing the list of potential matches 204a, 204b, the sonification system 50 may simultaneously display the visual cues 402a, 402b. Here, the sonification system 50 may emphasize (i.e., via changing the color, fond size, highlighting, shape, etc.) each visual cue 402a, 402b when the output audio signal 304 for the corresponding potential match 204a, 204b is rendered.

Notably, the playback sound-field 302 may be optimized for more than one user position (e.g., driver, passenger, rear passenger) in the vehicle 10. In other words, the playback sound-field 302 may be rendered based on the location of the user 102 within the vehicle 10. Because the user 102 that issued the query 24 is the person likely controlling the navigation for the vehicle 10, the playback sound-field 302 advantageously is calibrated to the position of the user 102 that issued the query 24. Here, the audio data characterizing the spoken utterance of the query 24 may be captured by the microphone 20 of the vehicle 10 and indicate the particular location 310 of the user 102 within the cabin 300 of the vehicle 10. Thereafter, the modulator 220 produces the playback sound-field 302 such that the playback sound-field 302 is centered on the particular location 310 of the user 102 in the cabin 300.

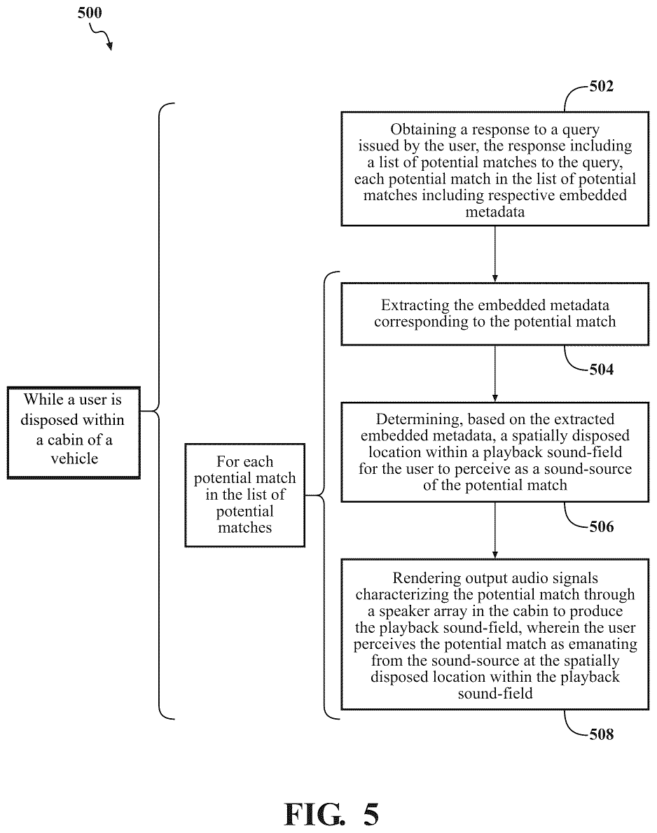

FIG. 5 includes a flowchart of an example arrangement of operations for a method 500 for the sonification of navigation search results. The method 500 may be described with reference to FIGS. 1-4, where the operations of the method 500 are performed while a user 102 is disposed within a cabin 300 of a vehicle 10. Data processing hardware (e.g., data processing hardware 12, 62 of FIG. 1) may execute instructions stored on memory hardware (e.g., memory hardware 14, 64 of FIG. 1) to perform the example arrangement of operations for the method 500. At operation 502, the method 500 includes obtaining a response 202 to a query 24 issued by the user 102. The response 202 includes a list of potential matches 204, 204a-n, each potential match 204 in the list of potential matches 204 including respective embedded metadata 206, 206a-n.

For each potential match 204 in the list of potential matches 204, the method 500 also includes the operations 504-508. In particular, at operation 504, the method 500 includes extracting the embedded metadata 206 corresponding to the potential match 204. At operation 506, the method 500 also includes determining, based on the extracted embedded metadata 206, a spatially disposed location 306 located within a playback sound-field 302 for the user 102 to perceive as a sound-source 308 of the potential match 204. The method 500 further includes, at operation 508, rendering output audio signals 304 characterizing the potential match 203 through a speaker array 16 in the cabin 300 to produce the playback sound-field 302. Here, the user 102 perceives the potential match 204 as emanating from the sound-source 308 at the spatially disposed location 306 within the playback sound-field 302.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method executing on data processing hardware that causes the data processing hardware to perform operations comprising:
while a user is disposed within a cabin of a vehicle:
obtaining a response to a query issued by the user, the response including a list of potential matches to the query, each potential match in the list of potential matches including respective embedded metadata;
for each potential match in the list of potential matches:
extracting the embedded metadata corresponding to the potential match;
determining, based on the extracted embedded metadata, a spatially disposed location within a playback sound-field for the user to perceive as a sound-source of the potential match; and
rendering output audio signals characterizing the potential match through a speaker array in the cabin to produce the playback sound-field, wherein the user perceives the potential match as emanating from the sound-source at the spatially disposed location within the playback sound-field.

2. The method of claim 1, wherein the operations further comprise receiving location information of the vehicle.

3. The method of claim 2, wherein rendering the output audio signals comprises modulating the output audio signals based on a distance between the location information of the vehicle and the embedded metadata of the potential match.

4. The method of claim 1, wherein the operations further comprise, while rendering the output audio signals characterizing the potential match, simultaneously displaying a corresponding visual cue in a graphical user interface of the vehicle.

5. The method of claim 1, wherein the operations further comprise identifying a user preference associated with one of the potential matches in the list of potential matches, the user preference stored in a user profile of the user.

6. The method of claim 5, wherein rendering the output audio signals characterizing the potential match associated with the user preference comprises rendering a user-defined audio output signal.

7. The method of claim 1, wherein the operations further comprise receiving audio data characterizing a spoken utterance of the query issued by the user and captured by a microphone in the cabin of the vehicle.

8. The method of claim 7, wherein the audio data characterizing the spoken utterance of the query indicates a particular location of the user in the cabin of the vehicle.

9. The method of claim 8, wherein the playback sound-field is centered on the particular location of the user in the cabin of the vehicle.

10. The method of claim 1, wherein the playback sound-field represents locations outside of the cabin of the vehicle.

11. A system comprising:
data processing hardware; and
memory hardware in communication with the data processing hardware, the memory hardware storing instructions that when executed on the data processing hardware cause the data processing hardware to perform operations comprising:
while a user is disposed within a cabin of a vehicle:
obtaining a response to a query issued by the user, the response including a list of potential matches to the query, each potential match in the list of potential matches including respective embedded metadata;
for each potential match in the list of potential matches:
extracting the embedded metadata corresponding to the potential match;
determining, based on the extracted embedded metadata, a spatially disposed location within a playback sound-field for the user to perceive as a sound-source of the potential match; and
rendering output audio signals characterizing the potential match through a speaker array in the cabin to produce the playback sound-field, wherein the user perceives the potential match as emanating from the sound-source at the spatially disposed location within the playback sound-field.

12. The system of claim 11, wherein the operations further comprise receiving location information of the vehicle.

13. The system of claim 12, wherein rendering the output audio signals comprises modulating the output audio signals based on a distance between the location information of the vehicle and the embedded metadata of the potential match.

14. The system of claim 11, wherein the operations further comprise, while rendering the output audio signals characterizing the potential match, simultaneously displaying a corresponding visual cue in a graphical user interface of the vehicle.

15. The system of claim 11, wherein the operations further comprise identifying a user preference associated with one of the potential matches in the list of potential matches, the user preference stored in a user profile of the user.

16. The system of claim 15, wherein rendering the output audio signals characterizing the potential match associated with the user preference comprises rendering a user-defined audio output signal.

17. The system of claim 11, wherein the operations further comprise receiving audio data characterizing a spoken utterance of the query issued by the user and captured by a microphone in the cabin of the vehicle.

18. The system of claim 17, wherein the audio data characterizing the spoken utterance of the query indicates a particular location of the user in the cabin of the vehicle.

19. The system of claim 18, wherein the playback sound-field is centered on the particular location of the user in the cabin of the vehicle.

20. The system of claim 11, wherein the playback sound-field represents locations outside of the cabin of the vehicle.
